(19) United States
(12) Patent Application Publication
(10) Pub. No.: US 2026/0024419 A1
(43) Pub. Date: Jan. 22, 2026

(54) PLAYER LOYALTY SYSTEM WITH GAMING INTERFACE

(71) Applicant: Everi Games Inc., Austin, TX (US)

(72) Inventors: Daniel Adrover, Pflugerville, TX (US); Connor Yarnott, River Falls, WI (US); Michelle Percival, Clarkston, MI (US); Christopher Ulrich, Ann Arbor, MI (US); Derek Smith, Las Vegas, NV (US)

(73) Assignee: Everi Games Inc., Austin, TX (US)

(21) Appl. No.: 18/775,069

(22) Filed: Jul. 17, 2024

(51) Int. Cl. G07F 17/34; G07F 17/32

(52) U.S. Cl. CPC G07F 17/34; G07F 17/3213; G07F 17/3255

(57) ABSTRACT

A player loyalty kiosk, system, method, and program product provide a loyalty game. A gaming interface of a loyalty game includes a matrix of symbol locations with a number of prize symbols, multiple expanding arrow symbols, and a moving highlight indicator. After a start input, a “stop” button is made active for stopping the moving highlight indicator. Responsive to a stop button input, the moving highlight indicator slows and then stops at a selected symbol on the matrix. If it stops on a prize symbol, a first type of game result provides an associated prize for the selected symbol. If it stops on an expanding arrow symbol, a second type of game result highlights an entire row or column of the matrix and provides prizes associated with each symbol location of the row or column.

### FIELD OF THE INVENTION

This invention relates casino player loyalty kiosk interfaces and to casino gaming machines and systems.

### BACKGROUND

Casino gaming networks often host a variety of slot machines at a casino site, and may provide remote gaming available in designated locations via smartphone applications or websites, with a backend server at the casino connecting the remote gaming device to the casino. Casino gaming networks also include player loyalty systems, which track players participation and provide promotions and other benefits in response to players meeting designated levels of participation. These levels may relate to amounts wagered through the casino or remote gaming, frequency of gaming, playing a number of different types of games, and other metrics which a casino provider may track relating to player activity.

Player loyalty systems often use a player loyalty kiosk placed in a casino for players to enroll in the system, obtain a player card, and interact with various features of the system to perform functions such as claiming promotional awards. Some of the features of a player loyalty kiosk may also be made available over a website or mobile application providing a remote, secure interface to the player loyalty system. In some cases, a player loyalty kiosk can also take deposits to allow players to add money to their slot machine credit accounts for play. A player loyalty kiosk may also be integrated with an ATM machine.

Casino gaming system manufacturers are continuously pressed to develop new ways to engage players with player loyalty systems, providing features such as loyalty games for which promotions and comps are awarded and loyalty groups which players participate in to obtain special features or comps, in an attempt to provide high entertainment value for players and thereby attract and keep players.

### SUMMARY OF THE INVENTION

The present invention encompasses a player loyalty system for a slot machine network, and a player loyalty kiosk, method, and program product, which provide a gaming interface for a player loyalty system. The gaming interface presents an interactive player loyalty game through which promotions and awards are provided.

According to one aspect of the invention, a player loyalty system for a slot machine network includes a player loyalty server and a player loyalty kiosk. The player loyalty server is operable to track player loyalty points on the slot machine network, provide awards and promotions accessible through a player loyalty interface, and provide player loyalty game results accessible through a gaming interface of the player loyalty interface. The player loyalty kiosk is coupled to the player loyalty server over a network, and includes a controller, a touchscreen display system coupled to the controller, a player card reader coupled to the controller, and one or more tangible non-transitory computer readable media holding a program product containing instructions for controlling operation of the player loyalty kiosk. The program instructions are executable for presenting an option through the touchscreen display to launch a player loyalty game for which a player is eligible. Responsive to a play input entered through a gaming interface of the player loyalty kiosk, the program causes a display system of the player loyalty kiosk to display a dynamic representation in a first area of the display system comprising a matrix of symbol locations including multiple columns and rows with at least: a number of prize symbols, multiple expanding arrow symbols, and a moving highlight indicator. Responsive to the play input, the program activates a “stop” button of the gaming interface. Responsive to receiving a player “stop” input at the stop button, the program causes the moving highlight indicator to slow its movement and then stop at a selected symbol location on the matrix. Responsive to the selected symbol being a prize symbol, the program provides a first type of game result including an associated prize for the selected symbol. Responsive to the selected symbol being one of the expanding arrow symbols, the program provides a second type of game result including highlighting an entire row or column of the matrix and providing prizes associated with each symbol location of the row or column.

According to another aspect, the invention is embodied as a player loyalty kiosk programmed to include the functionality described with respects to the system.

According to another aspect of the invention, a method is provided for controlling operation of a player loyalty kiosk. The method includes, responsive to a play input entered through a gaming interface of the player loyalty kiosk and under control of a processing system of the player loyalty kiosk, causing a display system of the player loyalty kiosk to display a dynamic representation in a first area of the display system comprising a matrix of symbol locations including multiple columns and rows with at least: a number of prize symbols, multiple expanding arrow symbols, and a moving highlight indicator which is shown to move among the matrix of symbol locations. Responsive to the play input, the method includes activating a “stop” button of the gaming interface, for stopping the moving highlight indicator. Responsive to receiving a player “stop” input through the stop button, the method includes causing the moving highlight indicator to slow its movement and then stop at a selected symbol on the matrix. Responsive to the selected symbol being a prize symbol, the method includes providing a first type of game result including an associated prize for the selected symbol. Responsive to the selected symbol being one of the expanding arrow symbols, the method includes providing a second type of game result including highlighting an entire row or column of the matrix and providing prizes associated with each symbol location of the row or column.

Yet another aspect of the invention is a computer program stored on one or more non-transitory computer readable medium. The software version is, of course, typically designed to be executed by a player loyalty system or kiosk, or a networked gaming system, to perform one of more of the methods described herein. The software includes multiple portions of computer executable code referred to as program code. Gaming results are provided in response to activations and displayed by display program code that generates the matrix of symbol locations as described below.

According to some implementations of the above aspects of the invention, a player loyalty server is accessed over a network to obtain a total prize amount in free play credits for the game result, and selecting a game result presenting the prize amount from among a number of game results including the first type and the second type.

According to some implementations of the above aspects of the invention, the gaming interface shows multiple expanding arrow symbols spinning or oscillating at respective symbol locations in the matrix while displaying the moving highlight indicator in motion.

According to some implementations of the above aspects of the invention, the multiple expanding arrow symbols are stopped from spinning or oscillating at their respective symbol locations when the moving highlight indicator is stopped.

According to some implementations of the above aspects of the invention, the prize symbols comprise a first type of prize symbol with a visible indication of an associated prize and a second type of prize symbol with no visible indication of an associated prize. The second type of prize symbol has a possibility of appearing multiple times in a highlighted row or column in a second type of game result.

Another aspect of the invention is a gaming machine performing one or more of the methods described herein. The gaming interface may provide a slot machine game in this aspect, which obtains a game result from a gaming server.

The various functionality described herein may be distributed between the player loyalty kiosk and the player loyalty server in any practically functional way. For example, the current preferred architecture is for the server to determine the prize award and the player loyalty kiosk or gaming machine to determine all aspects of game logic, game outcome generation, random number generation, and presentation. However, other embodiments of course might use a thin client architecture in which the animation is also conducted by the server and the player loyalty kiosk or gaming machine serves merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a game screen diagram illustrating showing a primary display of a player loyalty kiosk on which a game interface provides game results in primary display area.

FIG. 2-FIG. 8 are a series of game screen diagrams depicting a sequence of game screens employed in a game outcome according to some embodiments.

FIG. 9 shows a flow diagram of a process for operating a player loyalty kiosk according to some embodiments.

FIG. 10 shows a front perspective view of a player loyalty kiosk according to some embodiments.

FIG. 11 shows a hardware and logical block diagram of the player loyalty kiosk of FIG. 10.

FIG. 12 shows an example casino server network according to some embodiments.

### DETAILED DESCRIPTION OF EXAMPLE EMBODIMENTS

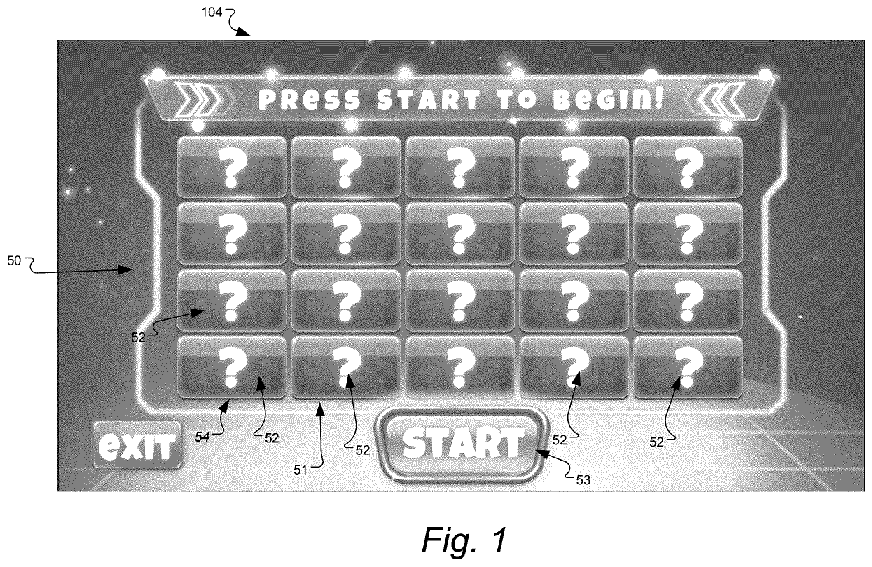

FIG. 1 is a game screen diagram illustrating a primary display 104 of a player loyalty kiosk on which a game interface provides game results in primary display area 50. The primary display area 50 presents a symbol array type game, which in this version includes a matrix 51 of symbol locations 54 arranged in rows and columns. Symbols 52 are shown in each symbol location designated 54. In this implementation there are five columns with four symbol locations 54 in each, but the game interface can be provided with a different number and size of columns. A start button 53 receives touch inputs to start game play.

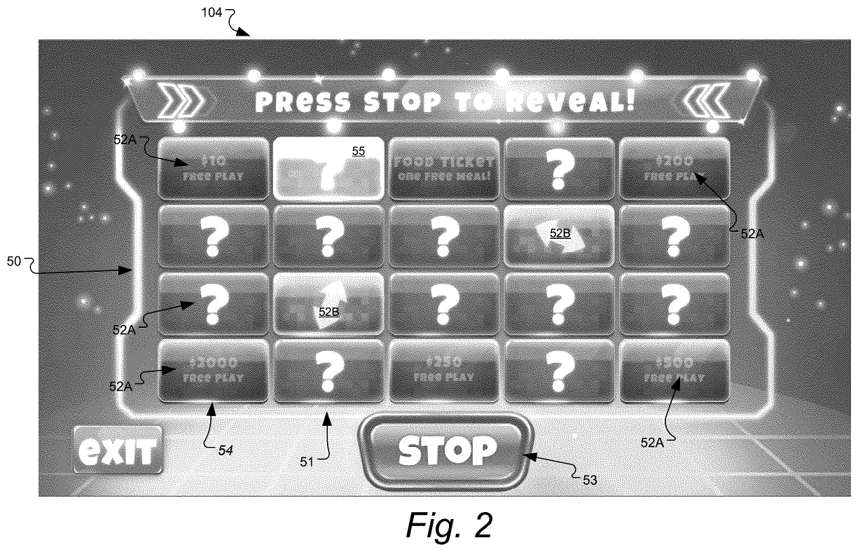

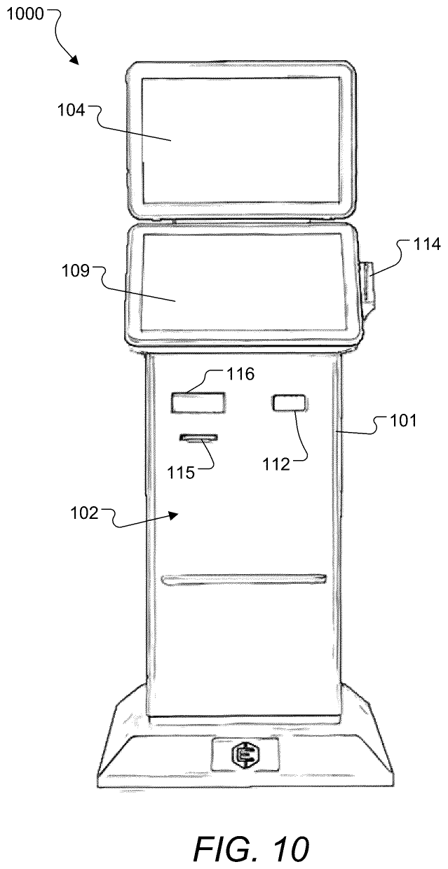

FIG. 2-FIG. 8 are a series of game screen diagrams depicting a sequence of game screens employed in providing a game outcome according to some embodiments. In this embodiment the depicted game interface is provided as a player loyalty game interface through a player loyalty system interface kiosk (FIG. 10), while in other embodiments the game interface may be provided through a slot machine or other gaming interface device. As described below, symbols 52 in symbol locations 54 are updated and change their state through the gaming interface to provide the game.

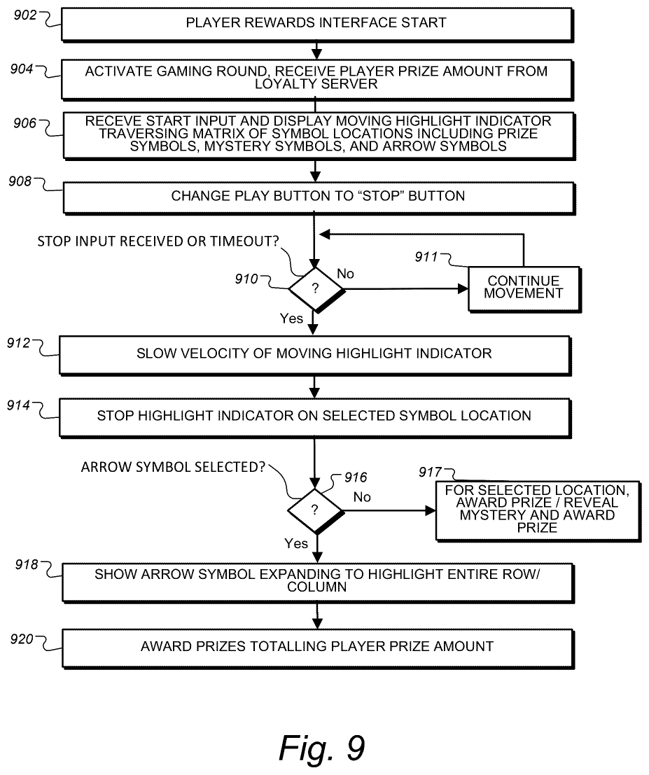

FIG. 9 shows a flow diagram of a process for operating a player loyalty kiosk according to some embodiments. The depicted process is one implementation suitable for providing the game interface described above with respect to FIG. 1-FIG. 8. In other embodiments, the process may be performed on a slot machine style electronic gaming machine and may be used to provide cash value results.

Referring to FIG. 1-FIG. 9, at block 902 the process includes a player rewards interface start, which occurs when a player logs into the player loyalty system through a loyalty kiosk or other loyalty system interface. In other embodiments, a slot machine or other gaming machine may be used to provide the gaming interface. Various other functionality related to the loyalty system is available after block 902, but will not be described here in detail. Generally, a player loyalty system provides an interface to a casino or gaming network membership programs through which players earn points or credits based on their wagers, deposits, or time spent at the casino. These points can then be redeemed for various rewards, such as complimentary meals, free play, hotel stays, show tickets, merchandise, or even cash back. Additionally, these programs help casinos gather valuable data about their customers' gambling habits and preferences, which can be used for targeted marketing and personalized offers to further enhance the customer experience and drive revenue. The depicted process shows a game interface presented through the loyalty system through which a player can earn an award of free play credits.

The game interface is activated at block 904, in response to a player input activating the interface through a button or prompt such as “Play Daily Loyalty Bonus Game”. A number of different loyalty games may be available for activation, selected based on a set of games for which the player is eligible, or a set of preferences, or both. In this embodiment, the game interface presents a “prize first” type of game, in which a prize amount of free play credits or other promotions is received from the loyalty server and used in presenting the game interface as shown at block 904. Other embodiments may employ a random process in which random numbers determine movement on the matrix of symbol locations and the prize amount is unknown until the game round completes and selects the prize. The depicted process includes requesting and receiving the player prize amount from a server, and receiving the request at the server and providing the prize amount back to the kiosk or other requesting machine. Then the game software randomly selects an outcome from a group of outcomes which all provide the player prize amount. This outcome is presented through the gaming interface using the depicted process.

For block 904, the game presentation shown in the example screen diagram of FIG. 1 shows the status of the gaming interface, including matrix 51 of symbol locations 54 each holding a mystery symbol 52. Other embodiments may, of course, have a different display before the Start button is pressed.

At block 906, responsive to a player “Start” input entered through a gaming interface of the loyalty kiosk, such as the Start button 53 shown in FIG. 1, the process includes causing a display system of the gaming machine to display a dynamic representation in a first display area 50 of the display system. As shown in the example of FIG. 2, the first display area 50 includes matrix 51 with a transformation of original symbols 52 into a number of prize symbols 52A, a number of expanding arrow symbols 52B. A moving highlight indicator 55 is also added to matrix 51. The process changes several of prize symbols 52A to reveal the prize associated with the respective symbols, and changes multiple mystery symbols 52 to arrow symbols 52B, while maintaining other symbols as mystery symbols. This change is seen in FIG. 2 where several maintains some of prize symbols 52A are question marks to indicate that they are a “mystery” symbol, that is, a prize symbol for which no information is given about the potential prize associated with it. Other embodiments may not make such a change. Several of the symbols shown in FIG. 2 are also left as “Mystery” symbols, showing a question mark and without any indication of the prize they provide before the game round is over.

Arrow symbols 52B function, if selected by the moving highlight indicator 55 at the end of the game round, to expand the selection along the direction they are pointing to provide all the prizes on a row or column. Arrow symbols 52B may be shown as spinning to indicate they can expand along either a column or a row. Arrow symbols 52B are preferably animated to be spinning, which may include continuous motion or discontinuous motion. For example, in this embodiment, arrow symbols 52B are shown to move in an oscillating motion between a horizontal orientation and a vertical orientation in which each movement is depicted as a ninety-degree spin. In other embodiments, the motion may be step-wise rotation in the same direction with ninety-degree steps. In this embodiment, the oscillating motion occurs regularly at a time interval selected to draw attention to the movement, such as less than a second separating oscillations. This movement continues until moving highlight indicator is stopped at block 914, and the arrow symbols are stopped in a final orientation.

Also responsive to the Start button activation, at block 908 the interface changes the functionality and graphics of “Start” button 53 to instead be a “Stop” button, which is made active to provide the function of stopping the moving highlight indicator 55 responsive to being pressed by the player. By active, it is meant the button is displayed and functional to receive a touch input from the player.

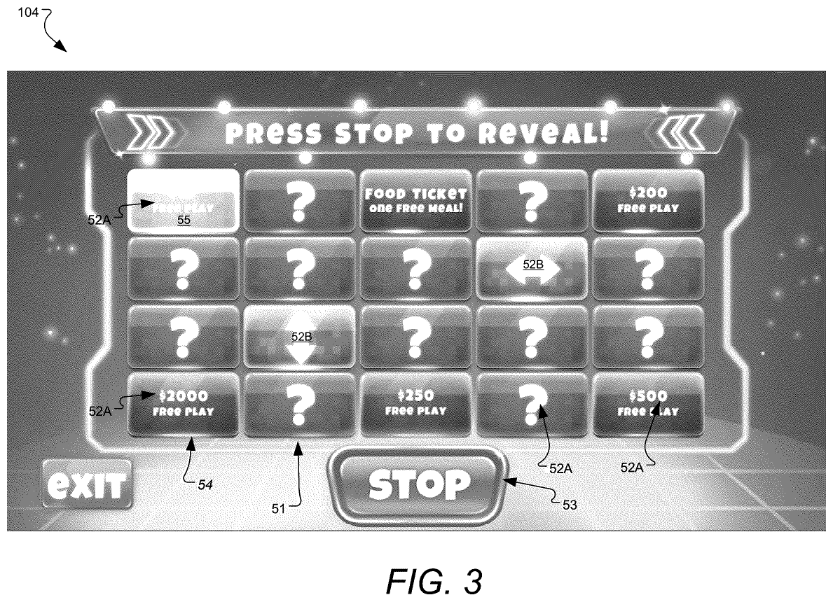

FIG. 3 shows a game screen diagram depicting the state of the game interface following that of FIG. 2. Moving highlight indicator 55 has moved to highlight the symbol 52 on the top left of matrix 51. As depicted, preferably moving highlight indicator 55 highlights a particular symbol location by brightening the appearance of the location. The symbol 52 at the symbol location 54 where moving highlight indicator 55 is located is still visible when highlighted, as seen by the “$10 Free Play” text visible at the highlighted symbol location 54 of FIG. 3. In this embodiment, moving highlight indicator 55 is shown as moving by disappearing from one symbol location 54 and immediately appearing in another symbol location 54, which can any of the other symbol locations. In other embodiments, moving highlight indicator 55 may be shown to move continuously between symbol locations 54, and may pause on locations or continue movement without a pause.

As shown by the loop at blocks 910 and 911 of FIG. 9 the process continues to display moving highlight indicator 55 until a stop input is received by the player pressing the Stop button depicted in FIG. 3. While no Stop input is received, or no timeout of this loop is reached, the process goes from block 910 to block 911 where it continues movement of moving highlight indicator 55 and goes back to block 910. When, at block 910, a Stop input is received or a timeout occurs, the process goes to block 912.

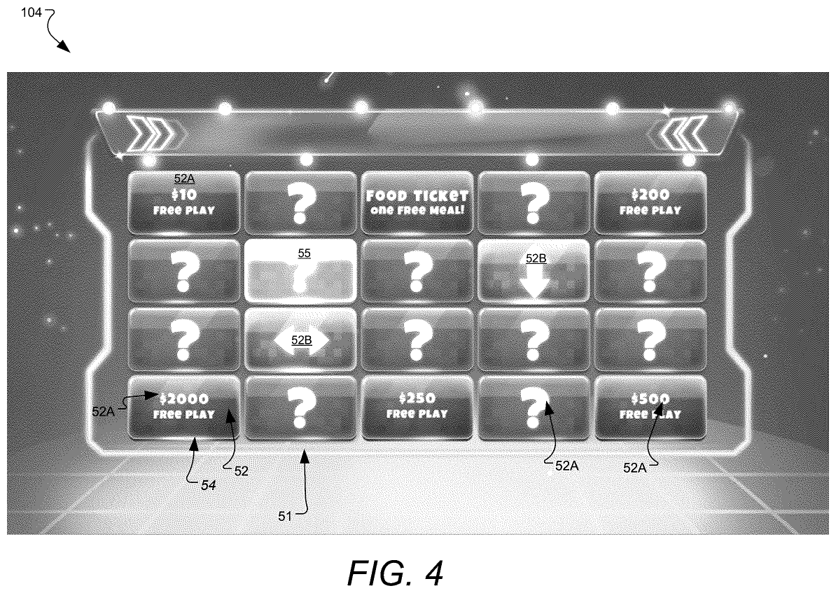

In this embodiment, at block 912 the process slows the movement of moving highlight indicator 55, and removes the Stop button from the game interface, producing a state like that depicted in FIG. 4. Moving highlight indicator 55 is shown to move one or a few more spaces with a slower velocity. For embodiments in which moving highlight indicator 55 disappears and reappears to show movement, the period of time it is shown appearing at a symbol location is increased to show the slower movement. For embodiments in which continuous movement between symbols is used, the velocity of the depicted continuous movement is slowed at block 912.

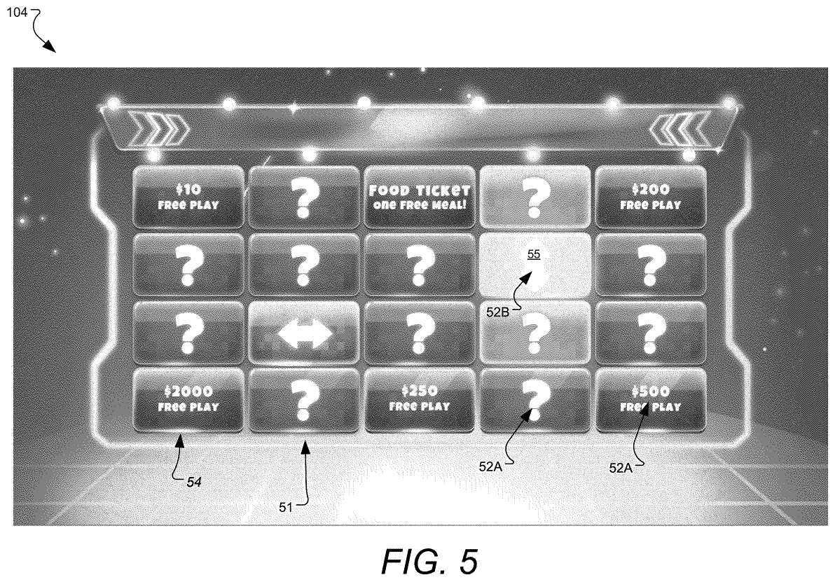

Next, at block 914, the process stops moving highlight indicator 55 at a selected symbol location for providing the prize amount provided at block 904. This state is shown in FIG. 5, with moving highlight indicator 55 shown stopped on an arrow symbol. At this point in the process, the arrow symbol 52B stops spinning and its final orientation, in this example vertical, is used to provide the game result.

At block 916, the process enters a phase of providing a game result, which has the possibility of occurring in different ways. In this embodiment one way of presenting a result at blocks 918 and 920 is highlighting an entire row or column of the matrix and providing prizes associated with each symbol location of the row or column if the symbol at the selected symbol location is an expanding arrow symbol. Another way of presenting a game result is shown at block 917 and includes providing an associated prize if the symbol at the selected symbol location is a prize symbol. If the selected symbol location is a mystery symbol, depicted by the question marks in FIGS. 2-7, an additional step of revealing a prize associated with the mystery symbol is included.

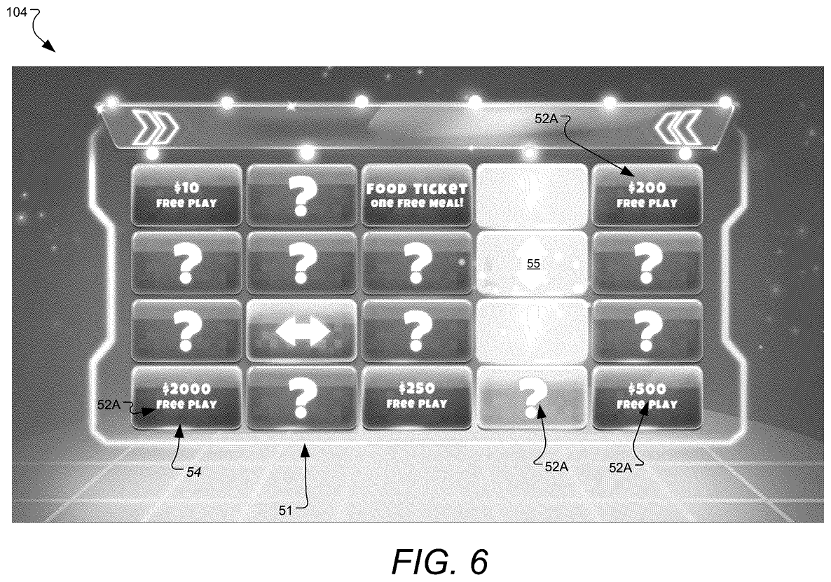

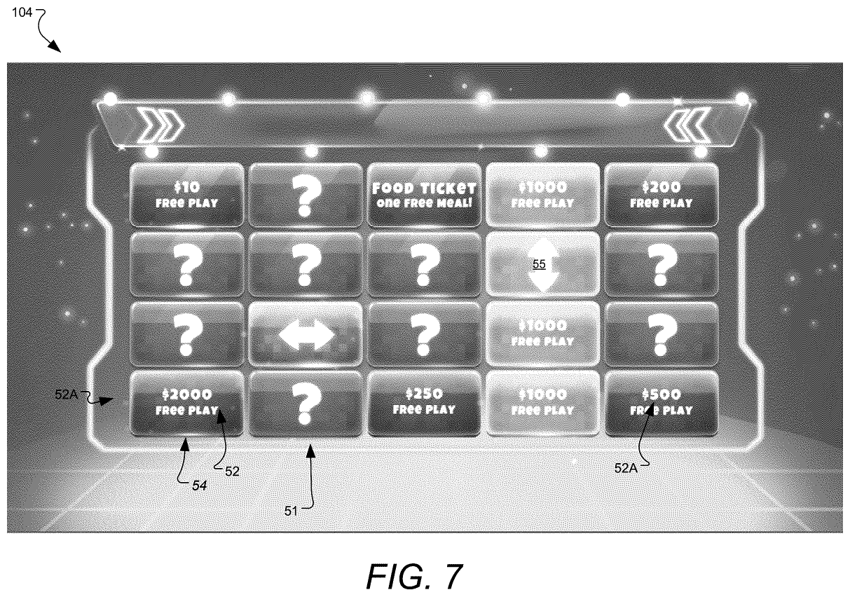

At block 916, if an arrow symbol is selected by the location of the stopped moving highlight indicator 55, the process goes to block 918 where it shows the arrow symbol expanding to highlight an entire row or column, whichever the double-sided arrow symbols point along. An example of this part of the process is depicted in FIG. 6 and FIG. 7, which show moving highlight indicator 55, which has stopped on an arrow symbol, activating the arrow symbols expansion functionality. As seen in FIG. 6, an arrow symbol under the stopped highlight indicator 55 is animated to show the highlighted effect expanding in the directions indicated by the two-sided arrow symbol. This process visually illustrates the effect of more symbol locations 54 being selected. Then, the selected symbols are shown highlighted or in different colors as illustrated in FIG. 7, to indicate that all of their respective prizes are part of the player's game result.

At block 920, the process awards the prizes from the indicated row or column, in this example a column, to provide the total prize award for the game round. At this step, all of the highlighted mystery symbols are altered to each display a respective associated award, which is awarded as part of game outcome. As discussed below, this embodiment the prizes are free play credits for use on a casino slot machine system. In other embodiments, other types of prizes may also be included.

Referring again to block 916, if no arrow symbol is selected when moving highlight indicator stops, the process goes to block 917 where it awards the prize associated with the symbol 52A at the symbol location 54 at which moving highlight indicator 55 has stopped. If that symbol location 54 has a mystery symbol, the prize associated with the mystery symbol is revealed and awarded.

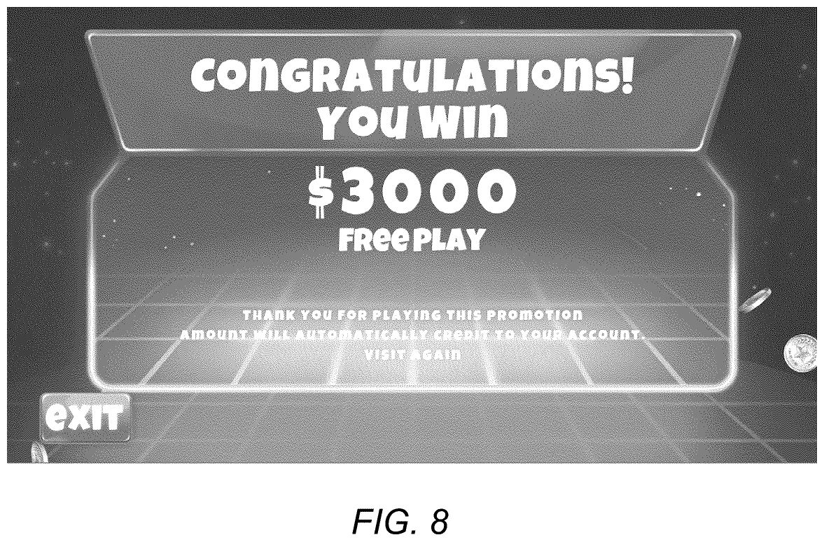

FIG. 8 shows the gaming interface following an award provided at either block 917 or block 920. In this example, the award is provided from block 920 and includes all the awards from the highlighted column depicted in FIG. 7. As can be seen in the message, a player loyalty promotion award, in this example totaling 3000 dollars of free play credits from the sum of prizes, is credited to the player's casino play account. If promotional awards such as comps are provided, they are credited to the player's loyalty account at this step and made redeemable through the player loyalty interface.

FIG. 10 shows a front perspective view of a player loyalty kiosk 1000 which includes a cabinet 101 having a front side generally shown at reference numeral 102. Player loyalty kiosk 1000 is one suitable implementation of a gaming machine for providing the gaming interface described above with respect to FIG. 1-FIG. 9. In this embodiment, the gaming interface provides a game with rewards of loyalty points such as free play points, which are provided by the player loyalty system and provide free play of with a single credit value per point, but cannot be redeemed for money. In other embodiments, a gaming machine such as a slot machine may be used, and the gaming interface may be used to provide a credit play game for cash value credit awards, or a points game for point awards having no cash value.

Player loyalty kiosk 1000 includes a display system including one or more display devices such as video displays. In the depicted version, the display system includes a primary video display device 104 which is mounted in an upper portion of the front side 102. Player loyalty kiosk 1000 also includes a lower auxiliary display device 109. Either or both of the display devices 104 and 109 may include touchscreen sensors. Either or both of display devices 104 and 109 may be used to present the gaming interface described above, and either or both may be used to present touchscreen controls for interfacing with a player loyalty system and for providing a gaming interface as described above. It should also be noted that each display device referenced herein may include any suitable display device including a cathode ray tube, liquid crystal display, plasma display, LED display, or any other type of display device currently known or that may be developed in the future.

Player loyalty kiosk 1000 may also include a number of other player interface devices in addition to devices that are considered player controls for use in playing a particular game. Player loyalty kiosk 1000 also includes a currency/voucher acceptor 112 having an input ramp, a player card reader having a player card input 114, and a voucher/receipt printer having a voucher/receipt output 115. In some embodiments, player loyalty kiosk 1000 also includes a currency dispenser 116, allowing kiosk 1000 to function as an ATM and/or a ticket-in-ticket-out (TITO) kiosk for redeeming player credits for currency. A near field communications (NFC) reader (not shown) may also be included on front face 102 for reading credit cards, debit cards, and/or player loyalty membership cards. One or more of these devices provides a credit input device in communication with the kiosk's controller and adapted for accepting a physical item associated with a monetary value that establishes a player credit balance.

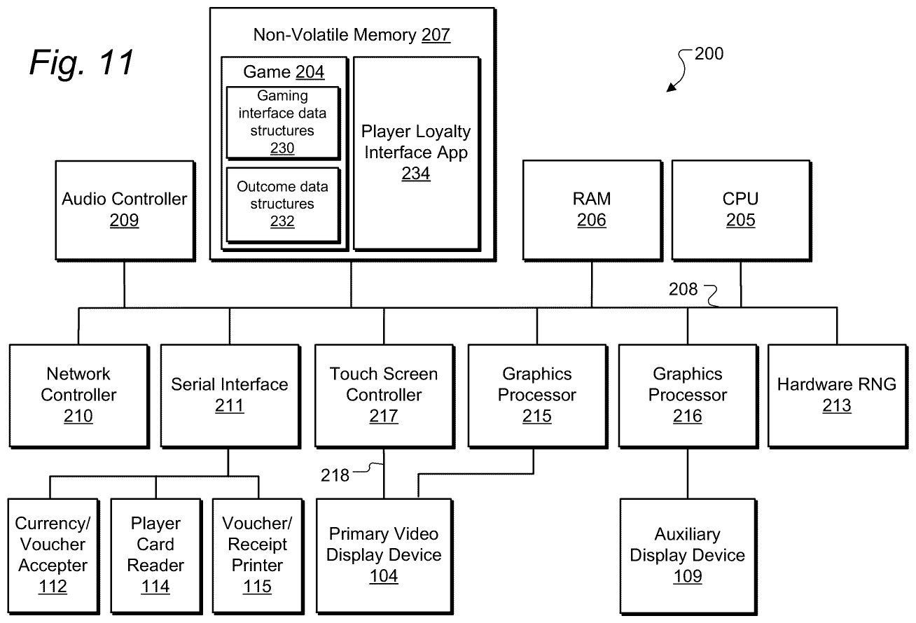

FIG. 11 shows a hardware and logical block diagram 200 of player loyalty kiosk 1000 which includes processing system with a central processing unit (CPU) 205 that acts as a controller and may include one or more electronic processors. The processing system also includes a random-access memory 206 and nonvolatile memory or storage device 207. All of these devices are connected on a system bus 208 with an audio controller 209, a network controller 210, and a serial interface 211. A graphics processor 215 is also connected on system bus 208 and is connected to drive primary display device 104 (mounted in cabinet 101 as shown in FIG. 10). A second graphics processor 216 is connected on system bus 208 in this example to drive the auxiliary display device 109 also shown in FIG. 11. Player loyalty kiosk 1000 also includes a touch screen controller 217 connected to system bus 208. Touch screen controller 217 is also connected via signal path 218 to receive signals from a touchscreen element associated with primary video display device 104. Another touch screen controller may also be included to receive signals from display 109. It will be appreciated that the touchscreen element itself typically comprises a thin film that is secured over the display surface of primary video display device 104. The touchscreen element itself is not illustrated or referenced separately in the FIGS. Serial interface 211 provides communication from CPU 205 to currency/voucher acceptor 112, player card reader having a player card input 114, voucher/receipt printer having a voucher/receipt output 115, and currency dispenser 116 (if a currency dispenser is included).

Those familiar with data processing devices and systems will appreciate that other common electronic components will be included in player loyalty kiosk 1000 such as a power supply, cooling systems for the various system components, audio amplifiers, and other devices that are common in gaming machines. These additional devices are omitted from the drawings so as not to obscure the present invention in unnecessary detail.

Elements 205, 206, 207, 208, 209, 210, 211, 215, 216, and 217 shown in FIG. 11 are known elements used in the loyalty kiosk industry. These elements are preferably mounted in a computer chassis which is housed in cabinet 101 shown in FIG. 10. Alternatively, the various electronic components may be mounted on one or more circuit boards or modules housed within cabinet 101 without a separate enclosure. Those familiar with data processing systems and the various data processing elements shown in FIG. 11 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 11 as being connected directly on system bus 208 may in fact communicate with the other system components through a suitable expansion bus. Audio controller 209, for example, may be connected to the system via a PCI bus. System bus 208 is shown in FIG. 11 merely to indicate that the various components are connected in some fashion for communication with CPU 205 and is not intended to limit the invention to any particular bus architecture. Numerous other variations in the gaming machine internal structure and system may be used without departing from the principles of the present invention.

Although separate graphics processor 215 is shown for controlling primary video display device 104, and graphics processor 216 is shown for controlling both auxiliary display device 109, it will be appreciated that CPU 205 may control all of the display devices directly without any intermediate graphics processor. The invention is not limited to any particular arrangement of processing devices for controlling the video display device included with player loyalty kiosk 1000. Also, a player loyalty kiosk or gaming machine implementing the present invention is not limited to any particular number of video display devices or other types of display devices.

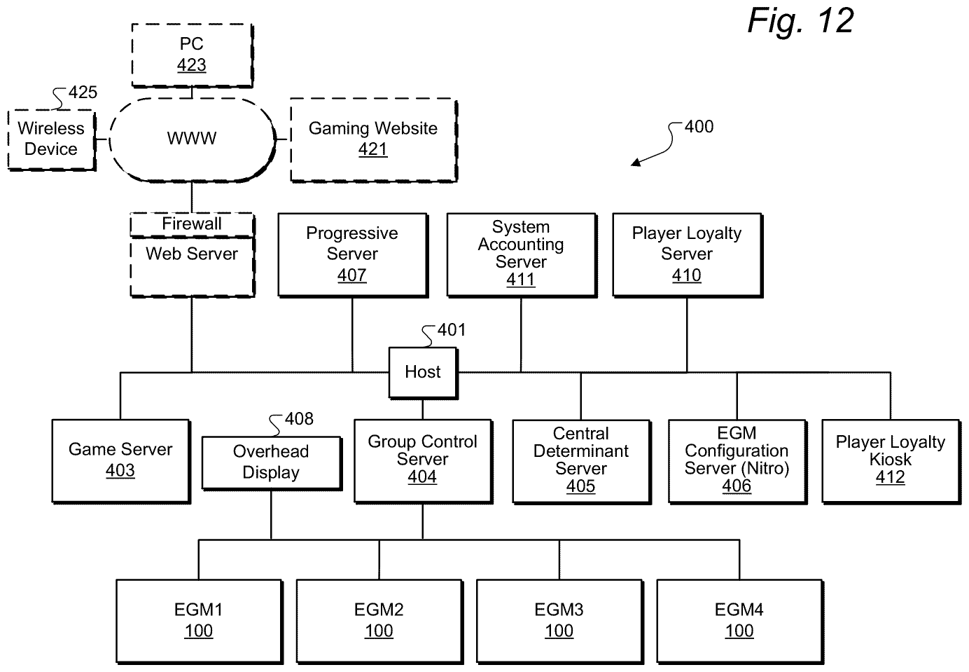

In the illustrated player loyalty kiosk 1000, CPU 205 executes a player loyalty interface application 234 which ultimately controls the player loyalty kiosk including normal tracking and accounting functions of a player loyalty kiosk such as voucher printing and reading, card reading, currency dispensing (if included), loyalty system enrollment, interfacing with player loyalty server 409 and player account server 410 (FIG. 12) to handle player credit balance transactions and obtain and distribute loyalty rewards such as free various rewards, such as complimentary meals, free play, hotel stays, show tickets, merchandise. CPU 205 controls receipt of player inputs and the presentation of the gaming interface according as described above through one or both of the display devices 104 and 109. As will be discussed further below, CPU 205 either alone or in combination with graphics processor 215 may implement a presentation controller for performing functions associated with a loyalty game 204 made available through the kiosk, and may also implement a game client for directing one or more display devices at the gaming machine to display the gaming interface according to the present invention. CPU 205 also executes software related to communications handled through network controller 210, and software related to various peripheral devices such as those connected to the system through audio controller 209, serial interface 211, and touch screen controller 217. Random access memory 206 provides memory for use by CPU 205 in executing its various software programs, while the nonvolatile memory or storage device 207 may comprise a hard drive or other mass storage device providing storage for programs not in use or for other data generated or used in the course of gaming machine operation. Network controller 210 provides an interface to other components of a gaming system in which gaming machine 100 is included.

It should be noted that the invention is not limited to player loyalty kiosks employing the arrangement of processing devices and interfaces shown in example gaming machine 100. Other kiosks or gaming machines through which the features herein are implemented may include one or more special purpose processing devices to perform the various processing steps for implementing the present invention, such as generating random numbers or checking the security status of software packages or gaming credit vouchers. Unlike processing devices such as CPU 205, these special purpose processing devices may not employ operational program code to direct the various processing steps.

Still referring to the hardware and logical block diagram 200 showing an example design for player loyalty kiosk 1000, the depicted player loyalty kiosk in operation is controlled generally by CPU 205 which stores operating programs and data in non-volatile memory or storage device 207 including game module 204, player loyalty interface application 234, and software or drivers for touch screen controller 217, network controller 210, audio/visual controllers, the devices on serial interface 211. In some embodiments, a hardware random number generator (RNG) 213 is included. RNG 213 is employed if software RNG technology is not allowed in a particular gaming jurisdiction, or if a hardware RNG is preferred for security or improved gaming functionality. Either hardware RNG 213 or a suitable software RNG are employed for making the random selections of game outcomes when operating the game as described herein.

CPU or CPU 205 may be implemented as a conventional microprocessor, such as an Intel microprocessor, mounted on a printed circuit board with supporting ports, drivers, memory, software, and firmware to communicate with and control kiosk operations through the execution of coding stored in non-volatile memory or storage device 207. As shown, one or primary game modules 204 are included, containing executable code and data structures, including a game script or executable for performing the game, gaming interface data structures 230 for providing the gaming interface as depicted above, and outcome data structures 232 for providing game outcomes used by the game module in presenting awards through the gaming interface. In operation, game module 204 executes to request and receive the prize first game outcome, make the selection of a game outcome from outcome data structures 232, and present the gaming interface using gaming interface data structures 230 to achieve the process of FIG. 9.

CPU 205 also connects through network controller 210 to a gaming network, such as example casino server network 400 shown in FIG. 12, including a player loyalty system. In some embodiments, separate logical or physical networks may implement the player loyalty system and the gaming network for security reasons.

FIG. 12 shows an example casino server network 400 according to some embodiments. Casino server network 400 may be implemented over one or more site locations and include host server 401, and an electronic gaming machine (EGM) configuration server 406 (in the preferred version the Everi Games Nitro Host server) for managing the configuration of multiple EGMs 100 on the network. A group display device 408 is coupled to casino server network 400 may include its own controller and graphics processor for driving a group display for a designated group of EGMs 100 in response to commands received over a network connection. The network may also include remote game play server 403 (which may be configured to provide game processor functionality including determining game outcomes and providing audio/visual instructions to a remote gaming device), a group control server 404 (which controls the gaming mode of the group of gaming machines including determining when to change the gaming mode and controlling the meters in the second gaming mode), central determinant server 405 (which may be configured to determine lottery, bingo, or other centrally determined game outcomes and provide the information to networked gaming machines 100 providing lottery and bingo-based wagering games to patrons), a progressive server 407 (which may be configured to accumulate a progressive pool from a portion of wagering proceeds or operator marketing funds and to award progressive awards upon the occurrence of a progressive award winning event to one or more networked gaming machines 100), player loyalty server 410 (which may be configured to collect and store player information and/or awards and to provide player information to gaming machines 100 after receiving player identification information such as from a player card), and accounting server 411 (which may be configured to receive and store data from networked gaming machines 100 and to use the data to provide reports and analyses to an operator).

Player loyalty server 410 operates together with one or more player loyalty kiosks 412 and player loyalty tracking software running on each of EGMs 100 to provide a player loyalty system. The player loyalty kiosk depicted in FIG. 10 and shown in block diagram form in FIG. 11 is suitable for use as player loyalty kiosk 412.

Player loyalty server 410 may maintain player account records, and store persistent player data such as accumulated player points and/or player preferences. For example, the player tracking display may be programmed to display a player menu that may include a choice of personalized gaming selections that may be applied to a gaming machine 100 being played by the player. Player loyalty server 410 also provides an operator interface for configuring and providing loyalty rewards and promotions.

Through player loyalty kiosks 412, a player interface is provided to the loyalty system. Generally, the player interface provides enrollment functionality, account information, reward and promotion eligibility and distribution to the player, loyalty games, and other player loyalty system features. The enrollment features include the ability join enrollment groups or promotions for which the player may qualify. Player loyalty server 410 manages and provides the various prizes and promotions available through the player loyalty system through network communication with player loyalty kiosks 412 and EGMs 100. A website interface may also be provided in gaming website 421 for a player to manage their enrollment, enrollment groups, view their account information, and claim rewards and promotions available to them, including participation in loyalty games like that described herein.

Various rewards and promotions may be available through the player loyalty system including prizes, coupons and vouchers, “comps” (free services and products), loyalty point multipliers, slot machine free play credits, drawing entries, and promotional event enrollment, for example. Loyalty games provide an interactive gaming interface through which some or all of such rewards and promotions are made available. In the gaming interface described herein, for example, game prizes may provide slot machine free play credits that a player has earned through loyalty points or other participation such as regular (daily, weekly) play. Other rewards and promotions such as those listed above may also be provided through the gaming interface described herein.

While a player loyalty system including player loyalty kiosks is described, certain player loyalty functionality may also be implemented on EGMs 100. In one or more embodiments, the player loyalty menu may be programmed to display after a player inserts a player card into the card reader of an EGM 100. When the card reader is inserted, an identification may be read from the card and transmitted to player loyalty server 410. Player loyalty server 410 transmits player information through network controller 210 for presenting player loyalty functionality on the display and user interface of the EGM 100. The player tracking display may provide a personalized welcome to the player, the player's current player points, and any additional personalized data and options for launching loyalty games and claiming rewards and promotions. In this embodiment, the player loyalty interface and gaming interface for loyalty games are presented by the player loyalty kiosk.

Through its network connection, an electronic gaming machine (EGM) 100 may be monitored by an operator through one or more servers to implement networked functions such as to assure proper operation, and, data and information may be shared between gaming machine 100 and respective of the servers in the network such as to accumulate or provide player loyalty points, to provide server-based games, or to pay server-based awards. While some of the servers have been shown separately, they may be combined or split into additional servers having additional capabilities.

As shown, networked electronic gaming machines 100 (EGM1-EGM4) and one or more overhead group displays 408 may be network connected and enable the content of one or more displays of gaming machines 100 to be mirrored or replayed on an overhead display. EGMs 100 may also feed celebration graphics directly to the overhead displays 408 in the course of providing games, for example to show a celebration for a large bonus win or group gaming mode win on a particular EGM 100. Typically, the overhead display function and group celebration scenarios are managed by a floor messaging server such as Nitro floor messaging server 404, which receives messages from EGM's 100 to communicate group gaming mode wins, bonus game wins, or awards of other large prizes such as progressive prizes.

In one or more embodiments, game server 403 may provide server-based games and/or game services to network connected gaming devices, such as gaming machines 100 (which may be connected by network cable or wirelessly). Progressive server 407 may accumulate progressive awards by receiving defined amounts (such as a percentage of the wagers from eligible gaming devices or by receiving funding from marketing or casino funds) and provide progressive awards to winning gaming devices upon a progressive event, such as a progressive jackpot game outcome or other triggering event such as a random or pseudo-random win determination at a networked gaming device or server (such as to provide a large potential award to players playing the community feature game). Accounting server 411 may receive gaming data from each of the networked gaming devices, perform audit functions, and provide data for analysis programs, such as the IGT Mariposa program bundle.

In one or more embodiments, a gaming website may be accessible by players, e.g. gaming website 421, whereon one or more games may be displayed as described herein and played by a player such as through the use of personal computer 423 or handheld wireless device 425 (e.g. Apple iPhone, Android phone, tablet, virtual reality device, iPad, etc.). To enter the website, a player may log in with a username (that may be associated with the player's account information stored on player loyalty server 410 or be accessible by a casino operator to obtain player data and provide promotional offers), play various games on the website, including the loyalty game with its gaming interface described herein, and save various personalizing selections so that during a next gaming session at a casino establishment, the player's playing data and personalized information may be associated with the player's account and accessible at the player's selected gaming machine 100.

Referring generally to the description herein, any use of ordinal terms such as “first,” “second,” “third,” etc., to refer to an element does not by itself connote any priority, precedence, or order of one element over another, or the temporal order in which acts of a method are performed. Rather, unless specifically stated otherwise, such ordinal terms are used merely as labels to distinguish one element having a certain name from another element having a same name (but for use of the ordinal term).

Further, as described herein, the various features have been provided in the context of various described embodiments, but may be used in other embodiments. The combinations of features described herein should not be interpreted to be limiting, and the features herein may be used in any working combination or sub-combination according to the invention. This description should therefore be interpreted as providing written support, under U.S. patent law and any relevant foreign patent laws, for any working combination or some sub-combination of the features herein.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method for controlling operation of a player loyalty kiosk, the method including:
responsive to a play input entered through a gaming interface of the player loyalty kiosk and under control of a processing system of the player loyalty kiosk, causing a display system of the player loyalty kiosk to display a dynamic representation in a first area of the display system comprising a matrix of symbol locations including multiple columns and rows with at least: a number of prize symbols, multiple expanding arrow symbols, and a moving highlight indicator;
responsive to the play input, activating a “stop” button of the gaming interface;
responsive to receiving a player “stop” input through the stop button, causing the moving highlight indicator to slow its movement and then stop at a selected symbol on the matrix;
responsive to the selected symbol being a prize symbol, providing a first type of game result including an associated prize for the selected symbol; and
responsive to the selected symbol being one of the expanding arrow symbols, providing a second type of game result including highlighting an entire row or column of the matrix and providing prizes associated with each symbol location of the row or column.

2. The method of claim 1 further comprising accessing a player loyalty server to obtain a total prize amount in free play credits for the game result, and selecting a game result presenting the prize amount from among a number of game results including the first type and the second type.

3. The method of claim 1 further comprising showing multiple expanding arrow symbols spinning or oscillating at respective symbol locations in the matrix while displaying the moving highlight indicator in motion.

4. The method of claim 3 further comprising stopping the multiple expanding arrow symbols from spinning or oscillating at their respective symbol locations when the moving highlight indicator is stopped.

5. The method of claim 1 wherein the prize symbols comprise a first type of prize symbol with a visible indication of an associated prize and a second type of prize symbol with no visible indication of an associated prize until selected in a first or second type of game result.

6. The method of claim 5 wherein the second type of prize symbol has a possibility of appearing multiple times in a highlighted row or column in a second type of game result.

7. A player loyalty system for a slot machine network comprising:
a player loyalty server operable to track player loyalty points on the slot machine network, provide awards and promotions accessible through a player loyalty interface, and provide player loyalty game results accessible through a gaming interface of the player loyalty interface;
a player loyalty kiosk coupled to the player loyalty server over a network, and including a controller, a touchscreen display system coupled to the controller, a player card reader coupled to the controller, and one or more tangible non-transitory computer readable media holding a program product containing instructions for controlling operation of the player loyalty kiosk, the instructions operable for:
presenting an option through the touchscreen display to launch a player loyalty game for which a player is eligible;
responsive to a play input entered through a gaming interface of the player loyalty kiosk, causing a display system of the player loyalty kiosk to display a dynamic representation in a first area of the display system comprising a matrix of symbol locations including multiple columns and rows with at least: a number of prize symbols, multiple expanding arrow symbols, and a moving highlight indicator;
responsive to the play input, activating a “stop” button of the gaming interface;
responsive to receiving a player “stop” input, causing the moving highlight indicator to slow its movement and then stop at a selected symbol location on the matrix;
responsive to the selected symbol being a prize symbol, providing a first type of game result including an associated prize for the selected symbol; and
responsive to the selected symbol being one of the expanding arrow symbols, providing a second type of game result including highlighting an entire row or column of the matrix and providing prizes associated with each symbol location of the row or column.

8. The player loyalty system of claim 7 wherein the instructions are further operable for accessing a player loyalty server to obtain a total prize amount in free play credits for the game result, and selecting a game result presenting the prize amount from among a number of game results including the first type and the second type.

9. The player loyalty system of claim 7 wherein the instructions are further operable for showing multiple expanding arrow symbols spinning or oscillating at respective symbol locations in the matrix while displaying the moving highlight indicator in motion.

10. The player loyalty system of claim 9 wherein the instructions are further operable for stopping the multiple expanding arrow symbols from spinning or oscillating at their respective symbol locations when the moving highlight indicator is stopped.

11. The player loyalty system of claim 7 wherein the prize symbols comprise a first type of prize symbol with a visible indication of an associated prize and a second type of prize symbol with no visible indication of an associated prize until selected in a first or second type of game result.

12. The player loyalty system of claim 11 wherein the second type of prize symbol has a possibility of appearing multiple times in a highlighted row or column in a second type of game result.

13. One or more tangible non-transitory computer readable media holding a program product for controlling operation of a player loyalty system including a player loyalty kiosk, the program product comprising machine readable instructions executable by a processing system for:
under control of a processing system of the player loyalty kiosk, storing a first data structure in a memory of the player loyalty system, the first data structure comprising data corresponding to a comprising a matrix of symbol locations including multiple columns and rows with at least: a number of prize symbols, multiple expanding arrow symbols, and a moving highlight indicator;
responsive to a play input entered through a gaming interface of the player loyalty system, causing a display system of the player loyalty system to display a dynamic representation in a first area of the display system comprising the matrix of symbol locations;
responsive to the play input, activating a “stop” button of the gaming interface;
responsive to receiving a player “stop” input, causing the moving highlight indicator to slow its movement and then stop at a selected symbol location on the matrix;
responsive to the selected symbol being a prize symbol, providing a first type of game result including an associated prize for the selected symbol; and
responsive to the selected symbol being one of the expanding arrow symbols, providing a second type of game result including highlighting an entire row or column of the matrix and providing prizes associated with each symbol location of the row or column.

14. The media of claim 13 wherein the instructions are further executable for:
accessing a player loyalty server to obtain a total prize amount in free play credits for the game result, and selecting a game result presenting the prize amount from among a number of game results including the first type and the second type.

15. The media of claim 13 wherein the instructions are further executable for:
showing multiple expanding arrow symbols spinning or oscillating at respective symbol locations in the matrix while displaying the moving highlight indicator in motion.

16. The media of claim 15 wherein the instructions are further executable for:
stopping the multiple expanding arrow symbols from spinning or oscillating at their respective symbol locations when the moving highlight indicator is stopped.

17. The media of claim 13 wherein:
the prize symbols comprise a first type of prize symbol with a visible indication of an associated prize and a second type of prize symbol with no visible indication of an associated prize until selected in a first or second type of game result.

18. The media of claim 17 wherein:
the second type of symbol has a possibility of appearing multiple times in a highlighted row or column in a second type of game result.
